(19) United States
(12) Patent Application Publication
(10) Pub. No.: US 2025/0316405 A1
(43) Pub. Date: Oct. 9, 2025

(54) Wire Harness and Wire Harness Manufacturing Method

(71) Applicant: Yazaki Corporation, Tokyo (JP)

(72) Inventor: Akitoshi Kimura, Aichi (JP)

(21) Appl. No.: 19/072,177

(22) Filed: Mar. 6, 2025

(30) Foreign Application Priority Data
Apr. 4, 2024 (JP) 2024-060527

(51) Int. Cl. H01B 7/00; B60R 16/02; H01B 13/012; H02G 3/04

(52) U.S. Cl. CPC H01B 7/0045; B60R 16/0215; H01B 13/01209; H02G 3/0456

(57) ABSTRACT

A wire harness includes an electric wire, a protector that includes a locked portion and protects the electric wire, and a lock member that includes a band insertion portion through which a band member is inserted and a locking portion locked to the locked portion, and that is fixed to the electric wire via the band member by winding the band member inserted through the band insertion portion around the electric wire. The electric wire is fixed to the protector by locking the locking portion of the lock member fixed to the electric wire to the locked portion of the protector.

### CROSS-REFERENCE TO RELATED APPLICATIONS

This application is based on and claims priority under 35 USC 119 from Japanese Patent Application No. 2024-060527 filed on Apr. 4, 2024, the entire content of which is incorporated herein by reference.

### TECHNICAL FIELD

The present disclosure relates to a wire harness routed in a vehicle such as an automobile, and a wire harness manufacturing method.

### BACKGROUND ART

As a wire harness in the related art, for example, a wire harness described in the following Patent Literature is known.

Briefly, for example, as shown in FIGS. 9A and 9B, a wire harness WH includes an electric wire 1 and a protector 2 that protects the electric wire 1, and the electric wire 1 is fixed to the protector 2 via a band member 3.

### CITATION LIST

### Patent Literature

Patent Literature 1: JP2021-093859A

### SUMMARY OF INVENTION

However, in the wire harness WH in the related art, the electric wire 1 is directly fixed to the protector 2 via the band member 3. Therefore, at the time of fixing the electric wire 1, it is necessary to fix the protector 2 to the electric wire 1 via the band member 3 after positioning and holding the electric wire 1 and the protector 2. Accordingly, an assembly work of the wire harness WH is complicated, and there is still room for improvement.

The present disclosure provides a wire harness and a wire harness manufacturing method that can improve productivity of the wire harness.

According to the present disclosure, a wire harness includes an electric wire, a protector that includes a locked portion and protects the electric wire, and a lock member that includes a band insertion portion through which a band member is inserted and a locking portion locked to the locked portion, and that is fixed to the electric wire via the band member by winding the band member inserted through the band insertion portion around the electric wire. The electric wire is fixed to the protector by locking the locking portion of the lock member fixed to the electric wire to the locked portion of the protector.

According to the present disclosure, the electric wire is fixed to the protector via the lock member attached to the electric wire by the band member. Therefore, after a necessary lock member is attached to a linear electric wire via the band member, a fixing work of the electric wire to the protector can be easily performed regardless of a shape of the protector by simply locking the locking portion of the lock member to the locked portion of the protector, and thus automation of the wire harness is promoted, and the productivity of the wire harness can be improved.

### BRIEF DESCRIPTION OF DRAWINGS

FIG. 1 is a perspective view of a wire harness according to a first embodiment of the present disclosure;

FIG. 2 is a cross-sectional view taken along a line A-A in FIG. 1;

FIGS. 3A and 3B are perspective views showing a method for manufacturing the wire harness shown in FIG. 1, in which FIG. 3A is a view showing a lock member attachment step, and FIG. 3B is a view showing a protector attachment step;

FIG. 4 is a perspective view of a wire harness according to a second embodiment of the present disclosure;

FIG. 5 is a cross-sectional view taken along a line B-B in FIG. 4;

FIG. 6 is a perspective view of a lock member showing a modification of the lock member;

FIGS. 7A and 7B are views showing a first reference example of the present disclosure, in which FIG. 7A is a perspective view, and FIG. 7B is a cross-sectional view taken along a line C-C in FIG. 7A;

FIGS. 8A and 8B are views showing a second reference example of the present disclosure, in which FIG. 8A is a perspective view, and FIG. 8B is a cross-sectional view taken along a line D-D in FIG. 8A; and

FIGS. 9A and 9B are perspective views of a wire harness in the related art.

### DESCRIPTION OF EMBODIMENTS

Hereinafter, embodiments of a wire harness and a wire harness manufacturing method according to the present disclosure will be described in detail with reference to the drawings. In the following embodiments, an example will be described in which the wire harness and the wire harness manufacturing method according to the present disclosure are applied to a wire harness routed in an automobile, similarly to a wire harness in the related art. In the description of the drawings, a direction in which a bottom wall 21 of a protector 2 extends is defined as an “X direction”, a direction in which a side wall 22 of the protector 2 extends is defined as a “Y direction”, and a direction which is orthogonal to an X-Y plane and in which an electric wire 1 extends is defined as a “Z direction”. In the Y direction, a side opposite to the bottom wall 21 is defined as “upper”, and a bottom wall 21 side is defined as “lower”.

### First Embodiment

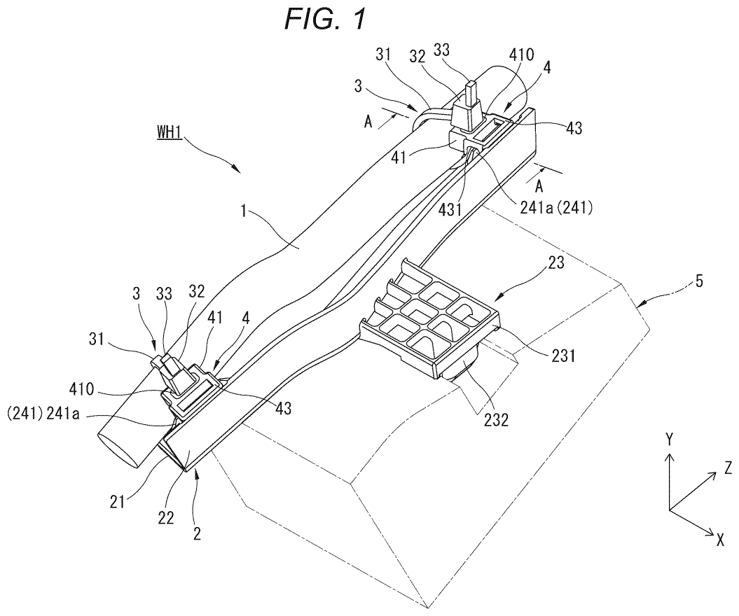

FIGS. 1 to 3B show a first embodiment of the wire harness and the wire harness manufacturing method according to the present disclosure.

### (Configuration of Wire Harness)

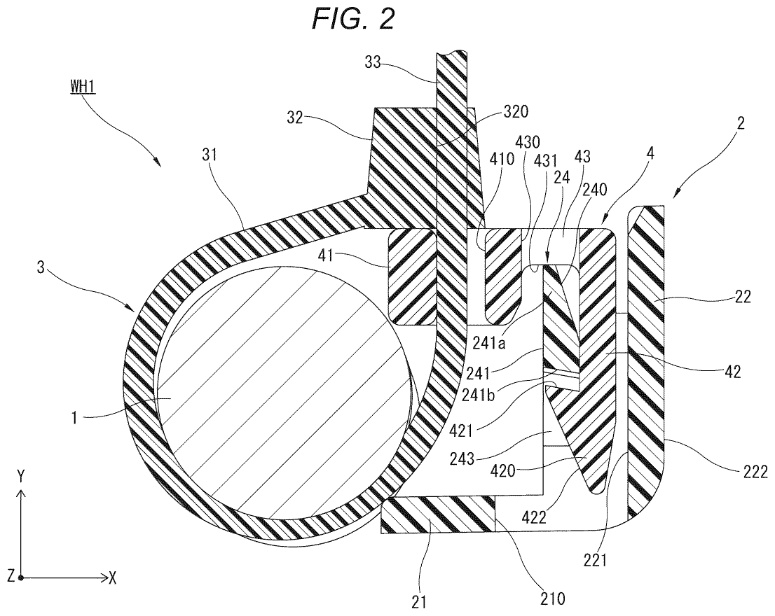

FIG. 1 shows a perspective view of a wire harness WH1 according to the present embodiment, and FIG. 2 shows a cross-sectional view of the wire harness WH1 taken along a line A-A in FIG. 1.

For example, as shown in FIGS. 1 and 2, the wire harness WH1 according to the present embodiment includes the electric wire 1 that is a well-known coated electric wire in which a core wire is covered with an insulating coating, the protector 2 that protects the electric wire 1, and lock members 4 that are fixed to the electric wire 1 via band members 3. That is, in the wire harness WH1, the electric wire 1 bent along a shape of the protector 2 is fixed to, for example, a vehicle body panel (not shown) via the protector 2.

The electric wire 1 is, for example, a well-known coated electric wire, and includes a core wire (not shown) and an insulating coating (not shown) that covers the core wire. The electric wire 1 usually has an entire length longer than that of the protector 2, and both end portions of the electric wire 1 are exposed from the respective end portions of the protector 2 in a longitudinal direction. In the present embodiment, although a specific illustration is omitted, in addition to the protector 2, various components used for routing the wire harness WH1, such as a clamp member, are attached to the electric wire 1 constituting the wire harness WH1 according to specifications of the wire harness WH1 or the like.

The protector 2 is made of, for example, an insulating synthetic resin. The protector 2 includes a protector main body constituted by the bottom wall 21 and the side wall 22, and a fixing portion 23 that fixes the protector main body to the vehicle body panel (not shown), which are integrally formed. In the present embodiment, the protector 2 is exemplified as having a three-dimensionally curved shape, but the protector 2 according to the present disclosure is not limited to the three-dimensionally curved shape, and can be formed in any shape according to a routing target, such as a linearly extending shape or a two-dimensionally bent shape.

The bottom wall 21 is formed in a curved plate shape along the vehicle body panel (not shown) on which the wire harness WH1 is routed. A substantially rectangular opening 210 is formed in the bottom wall 21 at a position facing a locked portion 24 to be described later. The side wall 22 rises substantially vertically from a side edge portion of the bottom wall 21, and the locked portion 24 to which a locking portion 42 of the lock member 4 can be locked is provided on an inner face 221 facing the electric wire 1. A plurality of locked portions 24 are arranged at any positions on the side wall 22, which are fixing positions of the electric wire 1 in an extending direction (Z direction) of the protector 2.

The locked portion 24 protrudes from the inner face 221 of the side wall 22 to a side facing the electric wire 1 in the X direction, and includes a locking wall 241 facing the electric wire 1 and a pair of connection walls 242, 242 connecting both sides of the locking wall 241 in the Z direction and the inner face 221 of the side wall 22. Accordingly, the locked portion 24 is formed in a substantially rectangular frame shape between the locked portion 24 and the inner face 221 of the side wall 22, and includes a lock insertion portion 240 inside penetrating along a height direction (Y direction) of the side wall 22. A lower end portion (end portion on the bottom wall 21 side in the Y direction) of the locking wall 241 is provided with a notch portion 243 that can accommodate a locking claw 420 to be described later of the lock member 4. Accordingly, the locking claw 420 to be described later of the lock member 4 can be locked to a lower end face 241b of the locking wall 241 corresponding to a Y-direction end face of the notch portion 243.

The fixing portion 23 integrally includes a plate-shaped attachment base portion 231 that extends laterally from an outer face of the side wall 22, and a locking protrusion 232 that protrudes substantially vertically from a lower face of the attachment base portion 231 and is locked to a locking hole (not shown) provided in a fixing target of the protector 2 such as the vehicle body panel (not shown). In addition to an aspect in which the fixing portion 23 is provided in a state of being offset with respect to the bottom wall 21 via the attachment base portion 231 as in the present embodiment, for example, the fixing portion 23 may be provided directly on a lower face of the bottom wall 21, and may be freely changed according to the specifications of the wire harness WH1 or the like.

The band member 3 is a well-known binding band made of, for example, an insulating synthetic resin, and integrally includes a band portion 31, a head portion 32, and a tail portion 33. The band portion 31 is formed in a flexible band shape, and is provided with a plurality of locking protrusions (not shown) formed at equal intervals in the longitudinal direction on one of front and back side faces. The head portion 32 is provided in a rectangular frame shape at one end portion of the band portion 31 in the longitudinal direction. A band insertion hole 320 through which the band portion 31 is inserted is provided in a penetrating state inside the head portion 32. A locking claw portion (not shown) that can be locked to the locking protrusion (not shown) of the band portion 31 is provided on an inner portion of the band insertion hole 320, and the locking protrusion (not shown) of the band portion 31 is locked to the locking claw portion (not shown), so that a bound state is maintained. The tail portion 33 is formed in a tapered shape at the other end portion of the band portion 31 in the longitudinal direction, and can be easily inserted into the head portion 32.

The lock member 4 is made of, for example, a synthetic resin, and integrally includes a band insertion portion 41, the locking portion 42, and a connection portion 43 that connects the band insertion portion 41 and the locking portion 42. The band insertion portion 41 is offset with respect to the locking portion 42 via the connection portion 43 toward a side (X direction) away from the side wall 22, and has a flat rectangular through hole 410 inside through which the band portion 31 can be inserted along the Y direction.

The locking portion 42 extends downward (downward in the Y direction) along the side wall 22 so as to overhang with respect to the band insertion portion 41 via the connection portion 43, and the locking claw 420 that can be locked to the notch portion 243 of the locked portion 24 is provided on an inner face of a tip end portion (lower end portion in the Y direction). The locking claw 420 is provided on the inner face of the locking portion 42 facing the electric wire 1 on a side opposite to the side wall 22 and protrudes laterally (in the X direction). Specifically, the locking claw 420 has a locking face 421 that can be locked to the lower end face 241b of the locking wall 241 facing the notch portion 243, and a tapered face 422 in which a protruding amount of the locking claw 420 gradually decreases from the locking face 421 in a tapered shape. Accordingly, the locking claw 420 is inserted into the lock insertion portion 240 of the locked portion 24 from an upper end side (upper side in the Y direction) of the side wall 22, passes through the lock insertion portion 240 and faces the notch portion 243 as the tapered face 422 pushes open the lock insertion portion 240 of the locked portion 24, and is locked to the locked portion 24 by the locking face 421 coming into contact with the lower end face 241b of the locking wall 241.

In a lower portion of the connection portion 43, a locking groove 431 is provided at a position in the X direction facing the locking face 421 of the locking claw 420 in the Y direction, and the locking groove 431 is recessed on a side away from the bottom wall 21 (upper side in the Y direction) and extends in the longitudinal direction (Z direction) of the protector 2. The locking groove 431 has a depth corresponding to a locking protrusion 241a protruding from an upper end portion (end portion opposite to the bottom wall 21 in the Y direction) of the locking wall 241 of the locked portion 24, and can be locked to the locking protrusion 241a. In other words, the lock member 4 is fixed to the locked portion 24 in a locked state by sandwiching the locking wall 241 between the locking claw 420 and the locking groove 431. In this way, by locking the locking groove 431 with the locking protrusion 241a, the locked state by the locking claw 420 is maintained in the locked portion 24, and movement (tilting) of the lock member 4 in the X direction is prevented. A through hole 430 as a thinned portion is provided in the connection portion 43 so as to penetrate along the Y direction.

### (Wire Harness Manufacturing Method)

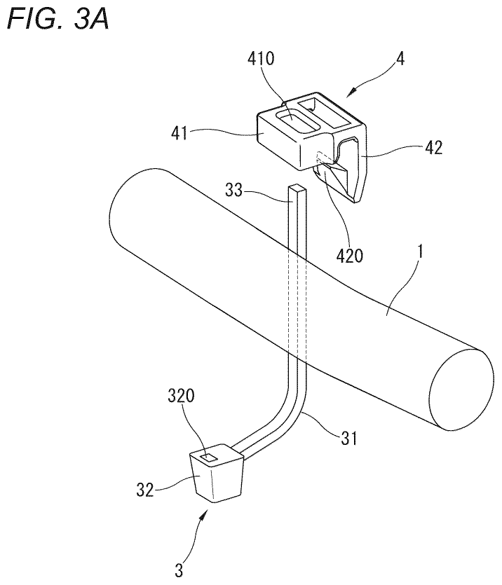

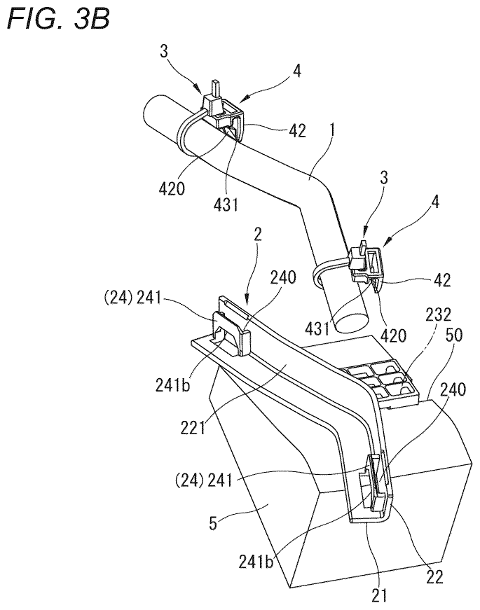

FIGS. 3A and 3B are perspective views of the wire harness WH1, showing a method for manufacturing the wire harness WH1 shown in FIG. 1, in which FIG. 3A shows a lock member attachment step, and FIG. 3B shows a protector attachment step. Hereinafter, the method for manufacturing the wire harness WH1 will be described with reference to FIGS. 3A and 3B.

First, as shown in FIG. 3A, the lock member 4 is attached to the electric wire 1. Specifically, the electric wire 1 is held horizontally. Subsequently, the band portion 31 of the band member 3 is inserted through the through hole 410 of the band insertion portion 41 of the lock member 4 from a tail portion 33 side. Thereafter, in a state where the lock member 4 is positioned by, for example, a jig (not shown), the band portion 31 inserted through the band insertion portion 41 is wound around an outer peripheral side of the electric wire 1, and the tail portion 33 is inserted through the band insertion hole 320 of the head portion 32, thereby binding the electric wire 1 and tightly binding and fixing the lock member 4 to the electric wire 1. Accordingly, the attachment of the lock member 4 to the electric wire 1 is completed.

Next, as shown in FIG. 3B, the protector 2 is attached to the electric wire 1. Specifically, the protector 2 positioned by inserting the locking protrusion 232 into a protrusion accommodating portion 50 formed in a recessed shape on an upper face of a protector holding jig 5 is placed on the protector holding jig 5. Thereafter, the locking portion 42 of each lock member 4 fixed to the electric wire 1 is pushed into the lock insertion portion 240 of the locked portion 24 of the protector 2, the locking wall 241 is sandwiched between the locking claw 420 and the locking groove 431, and the locking claw 420 is locked to the lower end face 241b of the locking wall 241. In this way, each lock member 4 is locked and fixed to the locked portion 24 of the protector 2, whereby the protector 2 is fixed to the electric wire 1 via each lock member 4. Accordingly, the attachment of the protector 2 to the electric wire 1 is completed, and the wire harness WH1 is completed.

### (Effects of Present Embodiment)

In a wire harness WH in the related art, the electric wire 1 is directly fixed to the protector 2 via the band member 3. Therefore, at the time of fixing the electric wire 1, it is necessary to fix the protector 2 to the electric wire 1 via the band member 3 after positioning and holding the electric wire 1 and the protector 2. Accordingly, an assembly work of the wire harness WH is complicated, and there is still room for improvement.

The protector 2 may have various three-dimensional shapes, such as a curved shape, according to a routing mode of the wire harness WH. On the other hand, when the protector 2 is fixed to the electric wire 1, it is necessary to fix the electric wire 1 and the protector 2 by the band member 3 after holding the electric wire 1 and the protector 2 in a horizontal state in order to ensure a predetermined dimension related to a relative positional relationship between the electric wire 1 and the protector 2, such as a distance between an end portion of the protector 2 in the longitudinal direction and a clamp member (not shown) attached to the electric wire 1 exposed from the end portion of the protector 2 in the longitudinal direction. Therefore, in the wire harness WH in the related art, depending on a shape of the protector 2, when the protector 2 is fixed to the electric wire 1, it is necessary to place the protector 2 on a plurality of protector holding jigs (first and second protector holding jigs 71 and 72) and hold the electric wire 1 and the protector 2 in a horizontal state at each fixing position by the band member 3.

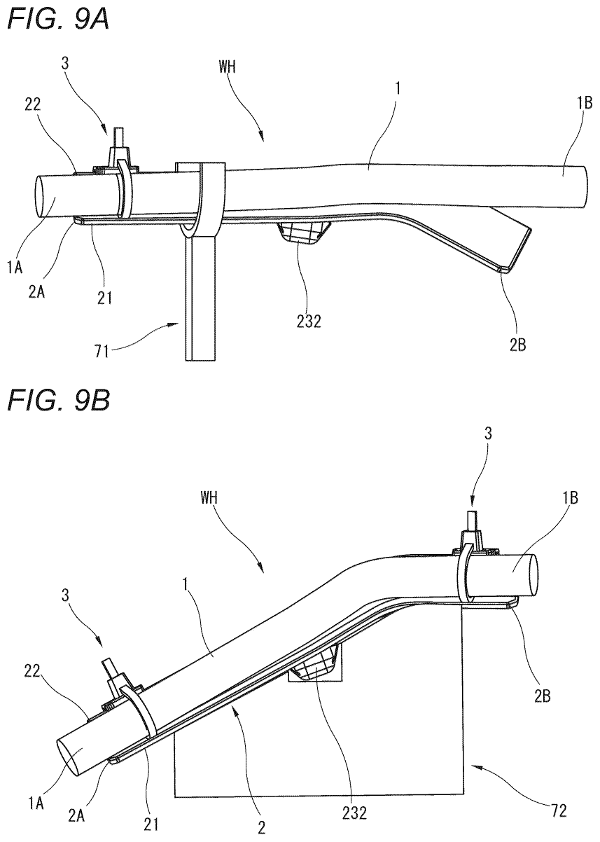

Specifically, for example, as shown in FIG. 9A, first, the protector 2 is placed on the first protector holding jig 71 to fix a first end portion 1A of the electric wire 1 to a first end portion 2A of the protector 2 via the band member 3 in a state where the first end portion 1A of the electric wire 1 and the first end portion of the protector 2 are horizontal. Thereafter, for example, as shown in FIG. 9B, the protector 2 is placed on the second protector holding jig 72, and a second end portion 1B of the electric wire 1 is fixed to a second end portion 2B of the protector 2 via the band member 3 in a state where the second end portion 1B of the electric wire 1 and the second end portion 2B of the protector 2 are horizontal. In this way, when the protector 2 is fixed to the electric wire 1, the protector 2 needs to be placed to the plurality of protector holding jigs (first and second protector holding jigs 71 and 72) at each fixing position, and thus there is room for improvement in that a fixing work of the protector 2 to the electric wire 1 is complicated and productivity of the wire harness WH is reduced.

In addition, in the wire harness WH in the related art, the protector 2 is directly fixed to the electric wire 1 via the band member 3, and thus when the protector 2 is fixed to the electric wire 1, it is necessary to fix the protector 2 to the electric wire 1 via the band member 3 after positioning and holding the electric wire 1 and the protector 2. Accordingly, it is difficult to automate the manufacture of the wire harness WH particularly when a three-dimensionally curved protector 2 is fixed to the electric wire 1, and there is still room for improvement from this viewpoint.

In contrast, in the wire harness WH1 according to the present embodiment, the electric wire 1 is fixed to the protector 2 via the lock member 4 attached to the electric wire 1 by the band member 3. Therefore, after the necessary lock member 4 is attached to the linear electric wire 1 via the band member 3, a fixing work of the electric wire 1 and the protector 2 can be easily performed regardless of the shape of the protector 2 by simply locking the locking portion 42 of the lock member 4 to the locked portion 24 of the protector 2, and thus automation of the wire harness WH1 is promoted, and productivity of the wire harness WH1 can be improved.

In other words, by disposing the lock member 4 at a predetermined position of the linear electric wire 1, it is not necessary to horizontally hold the fixing position at the time of fixing the protector 2 to the electric wire 1. Therefore, a plurality of protector holding jigs for holding the protector 2 in a horizontal state at each fixing position according to a shape of the protector 2 are not required, and it is not necessary to place the protector 2 on the plurality of protector holding jigs. Accordingly, the fixing work of the electric wire 1 and the protector 2 can be easily performed, and the productivity of the wire harness can be improved.

In the present embodiment, the protector 2 is fixed to the electric wire 1 via the lock member 4, and thus an arrangement dimension of the protector 2 with respect to the electric wire 1 can be ensured by disposing the lock member 4 at a predetermined position of the linear electric wire 1 regardless of the shape of the protector 2. Accordingly, automation of a binding work of the electric wire 1 and an attachment work of the lock member 4 to the electric wire 1 can be promoted, and the productivity of the wire harness WH1 can be improved.

In the present embodiment, the locked portion 24 is provided on the inner face 221 of the side wall 22 of the protector 2 facing the electric wire 1. Therefore, the lock member 4 and the locking portion 42 of the lock member 4 can be hidden between the electric wire 1 and the side wall 22 of the protector 2, the outer face 222 of the protector 2 exposed to the outside can be formed in a flat shape, and the lock member 4 can be prevented from being exposed to the outside. Accordingly, the appearance of the wire harness WH1 exposed to the outside is improved, and the aesthetics of the wire harness WH1 can be improved.

In the present embodiment, the locking groove 431 that can be locked to the locking protrusion 241a provided on the locking wall 241 of the locked portion 24 is provided in the lower portion of the connection portion 43 of the lock member 4 facing the locked portion 24. Accordingly, the attachment rigidity of the lock member 4 to the locked portion 24 of the protector 2 can be improved, and the protector 2 can be stably and firmly fixed to the electric wire 1.

### Second Embodiment

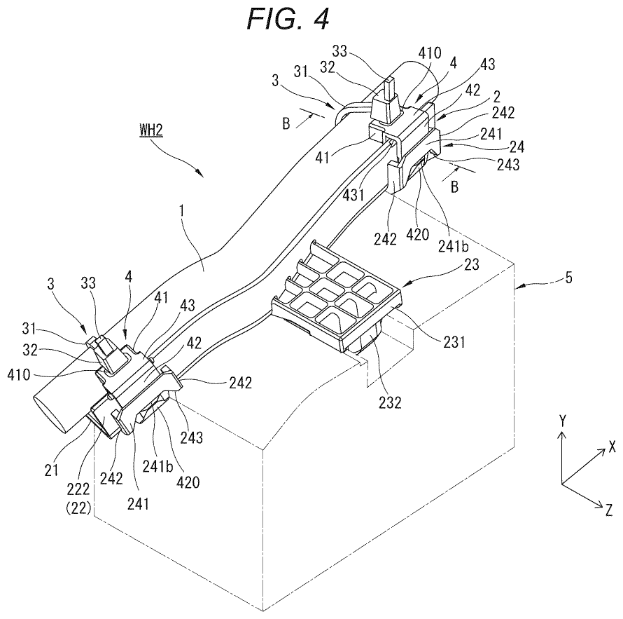

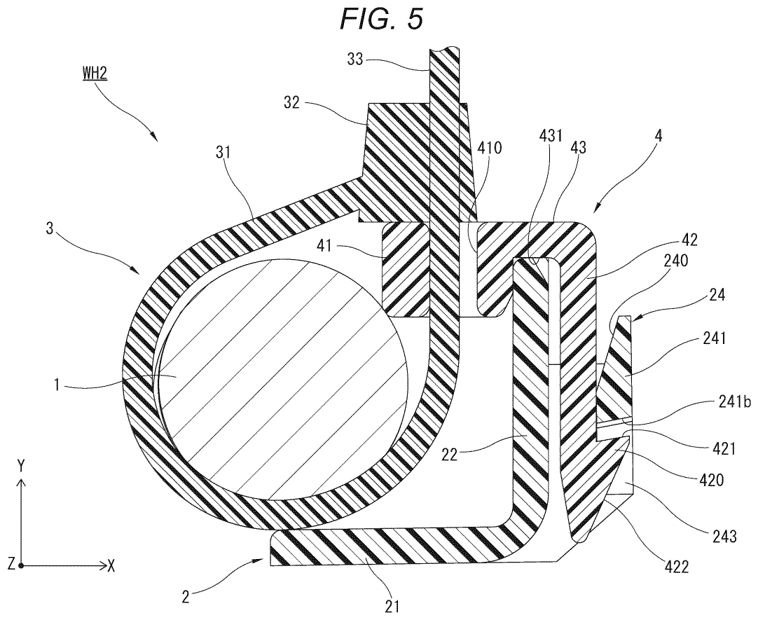

FIGS. 4 and 5 show a second embodiment of the wire harness and the wire harness manufacturing method according to the present disclosure, and the arrangement of the locked portion 24 according to the first embodiment is changed. Since the basic configuration other than such a change is the same as that of the first embodiment, the same configurations as those of the first embodiment are denoted by the same reference numerals, and the description thereof will be omitted.

For example, as shown in FIGS. 4 and 5, in a wire harness WH2 according to the present embodiment, the locked portion 24 of the protector 2 is provided on the outer face 222 of the side wall 22. That is, the locked portion 24 protrudes from the outer face 222 of the side wall 22 to a side opposite to the electric wire 1 in the X direction, and the lock insertion portion 240 is formed between the outer face 222 of the side wall 22 and the locking wall 241.

On the other hand, in the wire harness WH2 according to the present embodiment, in the lock member 4, the locking claw 420 that can be locked to the lower end face 241b of the locking wall 241 is provided on an outer face of the locking portion 42 facing the locking wall 241 of the locked portion 24. In the present embodiment, in a state where the locking portion 42 of the lock member 4 is inserted into the lock insertion portion 240 and the locking face 421 of the locking claw 420 is locked to the lower end face 241b of the locking wall 241, the locking groove 431 provided adjacent to the locking portion 42 of the lock member 4 can be locked to a tip end portion (upper end portion in the Y direction) of the side wall 22 of the protector 2.

As described above, in the wire harness WH2 according to the present embodiment, the locked portion 24 is provided on the outer face 222 of the side wall 22 of the protector 2 that does not face the electric wire 1. Therefore, the locked state of the locking portion 42 (locking claw 420) of the lock member 4 with respect to the locked portion 24 of the protector 2 can be visually recognized from the outside, and a fixing work of the protector 2 to the electric wire 1 via the lock member 4 can be accurately performed. Accordingly, it is possible to prevent assembly failure of the wire harness WH2 such as falling off due to locking failure of the lock member 4 with respect to the protector 2.

In the present embodiment, the locking groove 431 that can be locked to the tip end portion of the side wall 22 of the protector 2 is provided in the lower portion of the connection portion 43 of the lock member 4 facing the locked portion 24. Accordingly, the attachment rigidity of the lock member 4 to the locked portion 24 of the protector 2 can be improved, and the protector 2 can be stably and firmly fixed to the electric wire 1.

### (Modification of Lock Member)

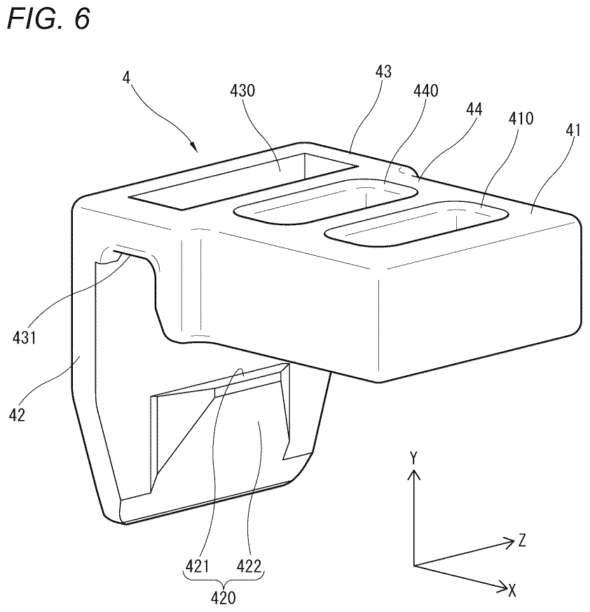

FIG. 6 is a perspective view of the lock member 4, showing a modification of the lock member 4.

For example, as shown in FIG. 6, in the lock member 4, the connection portion 43 connecting the band insertion portion 41 and the locking portion 42 is formed relatively long, and a pressing portion 44 that can be pressed in a locking direction of the locking portion 42 is provided between the band insertion portion 41 and the locking portion 42 in the X direction. A through hole 440 as a thinned portion is provided in the pressing portion 44 so as to penetrate along the Y direction.

As described above, in the present modification, in the lock member 4, the pressing portion 44 that can be pressed in the locking direction of the locking portion 42 is provided between the band insertion portion 41 and the locking portion 42. Therefore, when the lock member 4 is locked and fixed to the protector 2, the lock member 4 can be easily locked to the protector 2 by applying a pressing force via the pressing portion 44. Accordingly, a locking work of the lock member 4 with respect to the protector 2 is improved, and it is possible to contribute to the improvement of the productivity of the wire harnesses WH1 and WH2.

The present disclosure is not limited to the configuration illustrated in each of the above embodiments and the like, and can be freely changed according to specifications and the like of an application target without departing from the gist of the present disclosure, for example, a specific shape of the protector 2, a binding position of the electric wire 1 by the band member 3, and the number of the lock members 4.

### First Reference Example

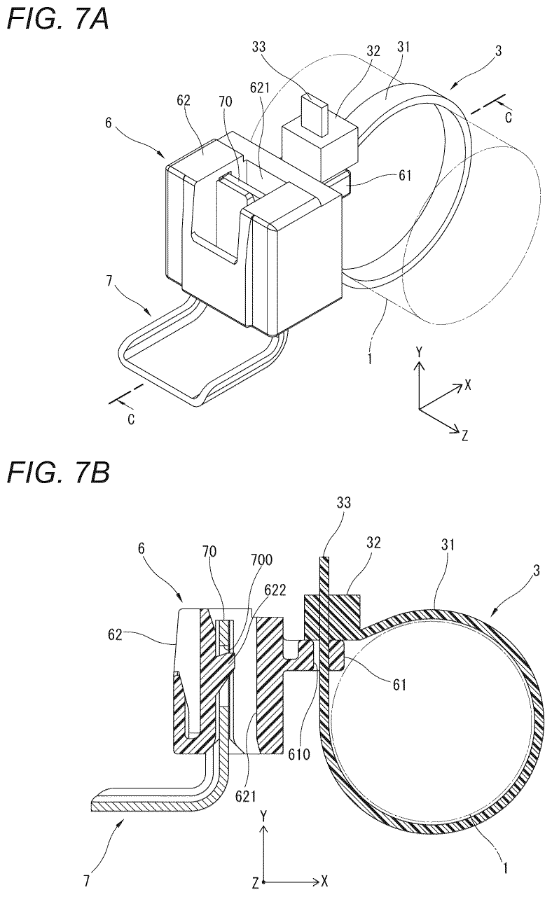

FIGS. 7A and 7B are views showing a first reference example of the present disclosure, in which FIG. 7A is a perspective view, and FIG. 7B is a cross-sectional view taken along a line C-C in FIG. 7A.

As the first reference example of the present disclosure, the lock member 4 disclosed in each of the above embodiments is formed integrally with a first bracket 6 fixed to a hook 7 provided on a vehicle body panel or the like (not shown), for example, as shown in FIGS. 7A and 7B. The first bracket 6 is locked and fixed to the hook 7 by locking a locking protrusion 622 provided inside a bracket insertion hole 621 penetrating a bracket insertion portion 62 provided in the first bracket 6 to a locking hole 700 provided in a tip end portion 70 of the hook 7. In this way, the electric wire 1 can be directly routed on the vehicle body panel or the like via the band member 3 inserted through a band insertion hole 610 penetrating a band insertion portion 61 provided in the first bracket 6 along the Y direction.

### Second Reference Example

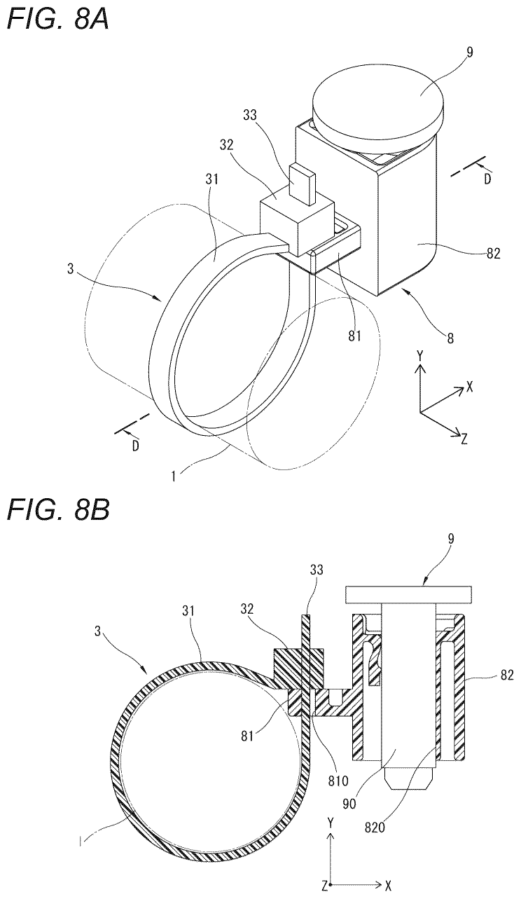

FIGS. 8A and 8B are views showing a second reference example of the present disclosure, in which FIG. 8A is a perspective view, and FIG. 8B is a cross-sectional view taken along a line D-D in FIG. 8A.

As the second reference example of the present disclosure, the lock member 4 disclosed in each of the above embodiments is formed integrally with a second bracket 8 attached to a vehicle body panel or the like (not shown) via a well-known bolt 9, for example, as shown in FIGS. 8A and 8B. The second bracket 8 is fastened to the vehicle body panel or the like (not shown) by screwing a shaft portion 90 of the bolt 9 inserted through a bolt insertion hole 820 penetrating a bolt insertion portion 82 provided in the second bracket 8 into a female screw hole (not shown) provided in the vehicle body panel or the like (not shown). In this way, the electric wire 1 can be directly routed on a vehicle body via the band member 3 inserted through a band insertion hole 810 penetrating a band insertion portion 81 provided in the second bracket 8 along the Y direction.

What is claimed is:

1. A wire harness comprising:
an electric wire;
a protector that includes a locked portion and protects the electric wire; and
a lock member that includes a band insertion portion through which a band member is inserted and a locking portion locked to the locked portion, and that is fixed to the electric wire via the band member by winding the band member inserted through the band insertion portion around the electric wire, wherein
the electric wire is fixed to the protector by locking the locking portion of the lock member fixed to the electric wire to the locked portion of the protector.

2. The wire harness according to claim 1, wherein
the protector includes the locked portion on an inner face facing the electric wire.

3. The wire harness according to claim 1, wherein
the protector includes the locked portion on an outer face that does not face the electric wire.

4. The wire harness according to claim 1, wherein
the locking portion overhangs from the band insertion portion,
a pressing portion capable of being pressed in a locking direction of the locking portion is provided between the band insertion portion and the locking portion, and
in the lock member, the locking portion is locked to the locked portion by being pushed into the locked portion with a pressing force applied via the pressing portion.

5. The wire harness according to claim 2, wherein
the protector includes, on the locked portion, a locking protrusion extending toward an insertion side of the lock member, and
the lock member includes, between the band insertion portion and the locking portion, a locking groove capable of being locked to the locking protrusion.

6. The wire harness according to claim 3, wherein
the protector includes a bottom wall that protects a bottom portion of the electric wire and a side wall that protects a side portion of the electric wire,
the locked portion is provided on an inner face of the side wall, and
the lock member includes, between the band insertion portion and the locking portion, a locking groove capable of being locked to a tip end portion of the side wall.

7. A wire harness manufacturing method, which is a method for manufacturing the wire harness according to claim 1, the method comprising:
a lock member attachment step of binding the electric wire and attaching the lock member to the electric wire via the band member inserted through the band insertion portion of the lock member; and
a protector attachment step of fixing the protector to the electric wire by locking the locking portion of the lock member to the locked portion of the protector.
